(19) United States
(12) Patent Application Publication
(10) Pub. No.: US 2010/0142226 A1
(43) Pub. Date: Jun. 10, 2010

(54) LIGHT GUIDE FOR A LIGHTING DEVICE

(75) Inventors: Hans-Michael Vogt, Bochum (DE); Mark Pilhofer, Neuss (DE); Christoph Michel, Remscheid (DE); Carsten Sambraus, Willich (DE); Norbert Schiffer, Niederzier (DE); Ulrich Kunze, Juechen (DE); Joachim C.R. Licht, Korschenbroich (DE); Elisabeth Cura, Duesseldorf (DE)

Correspondence Address: 3M INNOVATIVE PROPERTIES COMPANY, PO BOX 33427, ST. PAUL, MN, 55133-3427, US

(73) Assignee: 3M INNOVATIVE PROPERTIES COMPANY, Saint Paul, MN (US)

(21) Appl. No.: 12/376,255

(22) PCT Filed: Aug. 10, 2007
(86) PCT No.: PCT/US2007/075654

§ 371 Date: Feb. 2, 2010

(30) Foreign Application Priority Data
Aug. 10, 2006 (GB) 0615854.7

(51) Int. Cl. F21V 8/00

(52) U.S. Cl. 362/625; 362/634

(57) ABSTRACT

A lighting device comprises a side-light light guide (12) located in a support (13). To facilitate the location of the light guide (12) in the support (13) and ensure its retention in a predetermined orientation, at least one location feature (11) is formed on/in the light guide for engagement by the support. Advantageously, the/each location feature (11) has no substantial effect on the light output of the light guide through its light-emitting region (18).

### FIELD

The present invention relates to light guides for use in lighting devices. The invention is concerned, in particular, with light guides of the type that emit light along their length (hereinafter also referred to as “side-light guides”).

### BACKGROUND

Light guides are increasingly being used for decorative and functional lighting purposes in various locations, some of which require the light guide to emit light selectively (for example, comparatively uniformly or in a particular direction) along its length. Light guides of that type are known, as are various mechanisms by which light that is injected into a guide from a light source at one end is extracted from the guide along its length to provide, effectively, a linear lighting device. It is recognized that the use of side-light guides in linear lighting devices offers certain advantages: these include, for example, the possibility of using a low voltage light source such as an LED light source, and of separating the light source from the area in which the lighting device is actually located.

One form of side-light guide is described in EP-A-0 594 089 (in the name of Minnesota Mining and Manufacturing Company). The guide has light-extraction elements spaced along its length to cause light that is being propagated along the guide from at least one end thereof to be emitted selectively through a light-emitting region in the wall of the guide. In that case, the light-extraction elements comprise notches in the light guide, each notch having at least one reflecting surface of optical quality i.e. a surface that diffusely scatters only a small amount (generally less than 20%) of the light incident upon it. EP-A-0 956 472 (in the name of Minnesota Mining and Manufacturing Company) and EP-A-1 153 240 (in the name of 3M Innovative Properties Company) both describe other light guides of that type: in the guide described in EP-A-0 956 472, two sets of notches centered along different longitudinal axes are provided with a view to controlling the lateral distribution of light emitted by the guide while, in the guide described in EP-A-1 153 240, the notches have different notch angles with a view to producing a predetermined pattern in the illumination provided by the guide. Generally, light guides of that type offer the advantage that they can be designed to emit light very efficiently along their length and in a preferred direction with a pre-selected distribution, making them suitable for use in lighting devices in a wide number of applications.

Other forms of side-light guides are described, for example, in WO 99/22173, WO 00/25159 and WO 01/51851. WO 99/22173 (in the name of 3M Innovative Properties Company) describes a light guide comprising a core surrounded by cladding, in which the inner surface of the cladding is formed with indentations that cause light to be extracted from the light guide. A light-reflecting member may be provided around a portion of the light guide to redirect some of the extracted light in a particular direction. WO 00/25159 (in the name of Minnesota Mining and Manufacturing Company) describes a light guide comprising a core surrounded by a two-part cladding layer, in which the cladding incorporates various reflective materials to enhance the extraction and uniformity of the light emitted by the guide along its length. WO 01/51851 (in the name of 3M Innovative Properties Company) describes a light guide having light extraction structures spaced along its length to cause light to be directed from the light guide towards a diffuse reflective layer that, in turn, directs the light back through the light guide so that it is finally emitted through the region of the guide in which the light extraction structures are located.

Side-light guides are available in both flexible and rigid forms, and in materials that will not break or shatter and have a comparatively long useful life. They are also capable of providing a high level of illumination in an energy-efficient manner.

Lighting devices incorporating side-light guides have already been used in various locations. They can, for example, be used as cost effective, safe, versatile alternatives to fluorescent tubes in commercial, architectural, and consumer lighting applications but can also be used in situations in which fluorescent tubes are impractical and/or to achieve effects that cannot be obtained using conventional lighting devices. For example, there is increasing interest in the use of side-light guides in lighting devices in vehicles and it has already been proposed to use such devices on the outside of a vehicle, to outline features such as the rear window or the boot. More recently, car manufacturers have become interested in using side-light guides in lighting devices in car interiors for both practical and aesthetic reasons.

When a side-light guide is used in a lighting device, it is usually necessary to support the guide in some way, to retain it in the required position and ensure that light is emitted in the required direction. Known methods of supporting side-light guides include the use of brackets or clips (for example, as described in U.S. Pat. No. 6,763,172 of 3M Innovative Properties Company), and channels or rails (for example, as described in US 2004/0240829 also of 3M Innovative Properties Company, in WO 99/22174 of Minnesota Mining and Manufacturing Company, and in the above-mentioned WO 00/25159). In a particular case in which a rigid light guide is used in a lighting device for a car interior, the light guide is retained in a channel on the inside of the car door by resilient clips positioned at intervals along the channel. Because the light guide is rigid, the choices of the location and shape of the lighting device are necessarily restricted. Moreover, although it is comparatively easy to push the light guide into the resilient clips, there is a risk that it will be capable of small movements within the channel, producing a rattling noise that could annoy and distract the car driver.

Side-light light guides of the type that have a defined light-emitting region and are intended to provide a directed light output clearly have to be installed in the correct orientation in a lighting device. In certain situations, that can be difficult to achieve because the location of the light-emitting region of the guide is not always clearly apparent. Particular problems can arise if the guide is flexible because it may tend to twist, especially if it is being installed along a non-linear path.

### SUMMARY

The present invention is directed to the problem of facilitating the installation of a side-light guide securely in a support to form a lighting device. More especially, in the case in which the light guide has a defined light-emitting region, the invention is concerned with facilitating the installation of the light guide securely and in a particular orientation in a support to form a lighting device, advantageously without substantial detriment to the light output of the guide through the light-emitting region.

The present invention provides a lighting device comprising a side-light light guide located in a support, the light guide having, along at least part of its length, at least one location feature formed thereon/therein, the location feature(s) being engaged by the support to retain the light guide therein. Advantageously, in the case in which the light guide has a defined light-emitting region, the engagement of the support with the location feature(s) on/in the light guide also serves to retain the light guide in a predetermined orientation in the support.

The present invention provides a side-light light guide having a light-emitting region and, along at least part of its length, at least one location feature by which the guide can be retained in a predetermined orientation in a support, the location feature(s) being so formed and positioned on/in the guide that the light output of the guide through the light-emitting region is substantially unaffected thereby. The term “substantially unaffected” means that the total light output through the light-emitting region is reduced, if at all, by no more than 10% (preferably no more than 5%).

### BRIEF DESCRIPTION OF THE DRAWINGS

By way of example, light guides and lighting devices in accordance with the invention will be described with reference to the accompanying drawings, in which:

FIG. 1 is a diagrammatic longitudinal cross-section of a known light guide comprising light-extraction elements along its length;

FIG. 2 is a diagrammatic transverse cross-section of a light guide of the type shown in FIG. 1, illustrating a modification that enables the guide to be fitted into a pre-formed support;

FIG. 3 is a diagrammatic cross-section showing the light guide of FIG. 2 located in a pre-formed support of a lighting device;

FIG. 4 shows the lighting device of FIG. 3 installed in the interior of a vehicle door; and

FIGS. 5 to 11 are similar to FIG. 3 but show alternative shapes for the light guide and the support.

### DETAILED DESCRIPTION

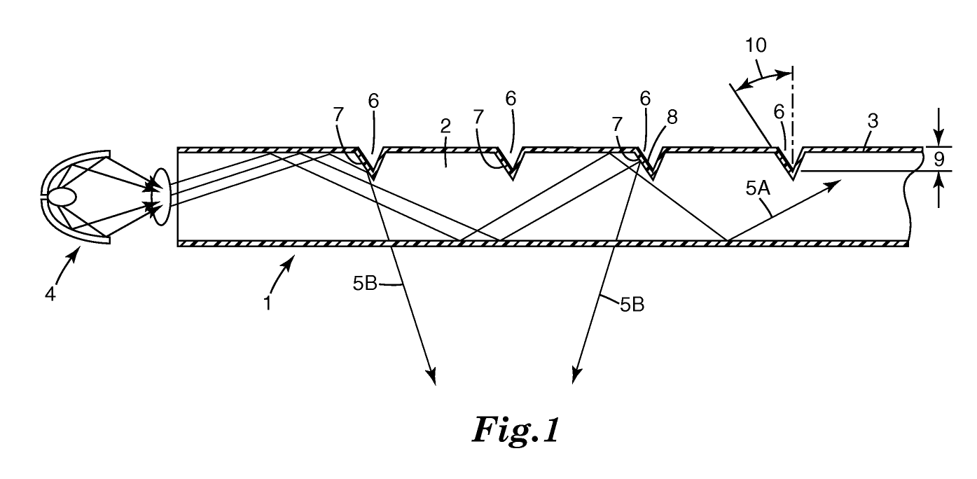

FIG. 1 shows, diagrammatically, an elongate light guide 1 of the type described in EP-A-0 594 089. The guide 1, which has a circular cross-section, comprises a solid core 2 formed from a suitable light-transmitting material and surrounded by a cladding material 3 having a lower refractive index than the core material. Light injected by a light source 4 into the guide 1 at one end will propagate along the guide in known manner, within the core 2, by total internal reflection at the interface between the core 2 and the cladding 3 as indicated by the ray 5A. Typically, the cladding material 3 is air (i.e. the guide consists solely of the naked core 2) but a specific coating of cladding material may be provided on the core if required.

The light guide 1 is provided, along its length and on one side, with spaced light-extraction elements 6 in the form of notches that extend into the guide core 2 (through the cladding layer 3 when present). As described in EP-A-0 594 089, the notches 6 comprise optically-smooth reflecting surfaces 7 that are designed to cause light which is incident on one of these surfaces while propagating along the guide core 2 to be diverted selectively out of the guide through a light-emitting region on the diametrically-opposite side of the guide 1, as indicated by the rays 5B. To minimize light loss through the surfaces 7 of the notches 6, those surfaces may be provided with a coating 8 of reflective material such as aluminum or silver.

A reflector (not shown) may be provided at the end of the light guide 1 remote from the light source 4 to return to the light guide any light that has not been diverted out of the guide by the notches 6. Alternatively, a second light source may be provided to inject light into the guide from that end.

A more detailed explanation of the effect of the notches 6 can be obtained, if required, from EP-A-0 594 089 together with a description of the various forms that these notches can take. Additional information concerning other forms of the notches, and their location on a light guide, can be obtained from EP-A-0 956 472; 1 153 240 and 1 509 791. In some cases, as described for example in U.S. Pat. No. 5,631,994, the notches 6 may be provided in an overlay located on the top of the light guide 1. Generally, the characteristics of the light output along the length of the guide 1 are determined by factors such as: the depth 9 of the notches 6 into the guide 1; the angles of inclination 10 of the notch surfaces 7; and the distance between the notches.

Light guides having light extraction elements in the form of notches 6 as described above can provide an efficient means of converting the light from a source 4 into an elongate form that can readily be adapted to meet particular lighting requirements. As already mentioned above, however, other forms of side-light guides incorporating other types of light extraction elements are also known.

When a light guide of the general type described above is used in a lighting device, it is usually necessary to provide a support by which the guide is held in the lighting device to emit light in the required direction. It should be possible to install the light guide quickly and easily in the correct orientation in the support, preferably without the use of special tools. Once installed, the light guide should be securely retained in position and the support will, typically, be required to have minimal detrimental impact on the light output of the guide.

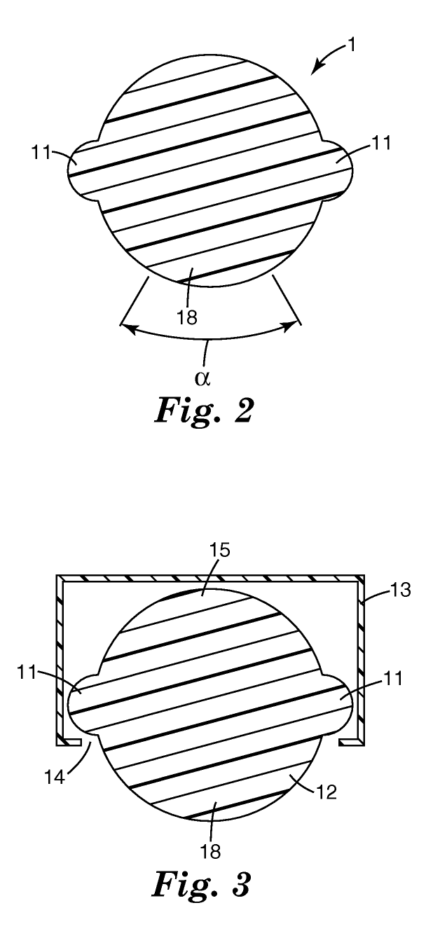

In accordance with the invention, to facilitate the installation of a light guide of the type shown in FIG. 1 in a support, the guide is modified by the provision of lengthwise-extending, diametrically-opposed location features 11 as shown in the transverse cross-section of FIG. 2. For the purposes of clarity, the light guide is shown in FIG. 2 (and in subsequent Figures) without any cladding material although such material could be provided if required. Each location feature 11 in FIG. 2 is in the form of a protuberance of semi-circular cross-section on the outer surface of the light guide and is intended to be engaged by the support (not shown), thereby enabling the latter to retain the light guide in the desired location and orientation in a lighting device.

It will be seen that the form of the light guide 1 of FIG. 1 is, effectively, still present in the modified form of FIG. 2 and it has been found that the light output of the unmodified guide can, if required, likewise be substantially retained despite the presence of the protuberances 11. More particularly, the protuberances 11 can be designed, having regard to the form and disposition of the light-extraction notches 6, so that the total light output through the light-emitting region 18 of the light guide (indicated as being contained by the angle α) is reduced, if at all, by no more than 10%, preferably no more than 5%. The change in light output (if any) due to the presence of the protuberances 11 can be determined by, for example, measuring the flux onto a surface located at a set distance from the light guide.

FIG. 3 illustrates a lighting device in accordance with the invention, comprising a light guide 12 of the modified type shown FIG. 2 installed in a support 13 that has the form of an elongate hollow rail of rectangular cross-section with an opening 14 in one side. The protuberances 11 on the light guide 12 are located on either side of the opening 14, on the inside of the support rail 13, and ensure that the light guide is retained inside the rail in the orientation illustrated. The light guide region 15 that contains the light-extraction notches 6 (not visible in FIG. 3) is located adjacent the inside rear face of the support rail 13, and the light-emitting region 18 of the light guide projects through the opening 14 to an extent sufficient to ensure that the light output of the guide is unaffected by the presence of the rail. As illustrated, the guide 12 is a comparatively close fit within the support rail 13 so that relative movement between the guide and the rail is minimized.

The support rail 13 will typically be formed from a plastic material, preferably one that is suitable for injection moulding, and may be selected for interior or exterior use as required. Advantageously, the characteristics of the material allow the light guide to be pushed into to the support rail 13 through the front opening 14 without the use of any special tools.

The light guide 12 can be formed from any suitable light-transmitting material including, for example, glass and polymeric materials such as acrylate, silicone and urethane materials. The guide may be comparatively rigid but is advantageously a flexible product that can be bent to follow a desired contour. In the latter case, the engagement between the protuberances 11 and the support rail 13 ensures that the light guide does not become twisted as it is being installed in the support rail but always remains in the desired radial orientation with the light-extraction notches 6 at the rear of the rail and the light-emitting region 18 of the guide projecting through the opening 14.

Preferably, the protuberances 11 are formed from the same light-transmitting material as the light guide 12 and are advantageously an integral part of the guide so that there is no discontinuity between the two. In that way, disruption of the light output of the light guide by the protuberances 11 can be minimized. For example, the light guide 12, including the light-extraction notches 6 and the protuberances 11 may be a moulded component. One method of manufacturing a light guide with light extraction notches by a moulding process is described in U.S. Pat. No. 6,077,462. It is, however, possible for the protuberances 11 to be formed separately and attached in any appropriate manner (for example, by a suitable adhesive) to a circular cross-section light guide 1 of the type shown in FIG. 1. The adhesive could be a light-transmitting adhesive, or one that would reflect light back into the light guide.

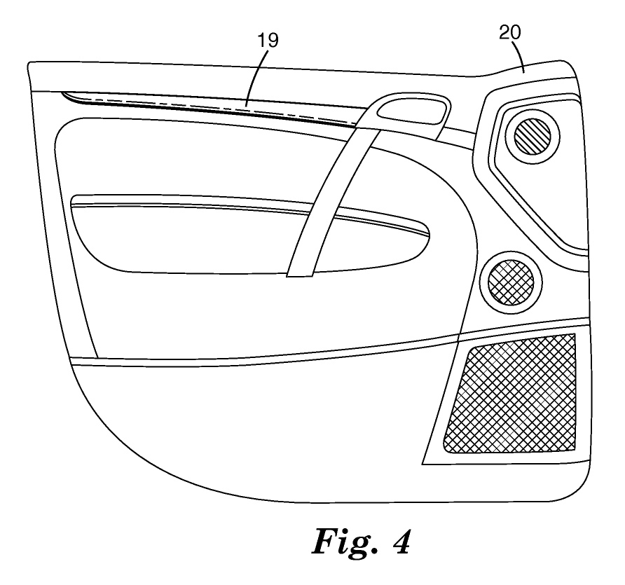

A lighting device as shown in FIG. 3 can be employed in many different lighting application, both aesthetic and practical. As already mentioned, there is increasing interest in using lighting devices that incorporate side-light guides in road vehicles, for interior and exterior lighting. However, they can also be used in other vehicles, including all forms of public transport and for many other purposes including, for example: ambient lighting in domestic and industrial buildings; advertising (as replacements for neon lights); and internal lighting in appliances such as refrigerators. In all such locations, a lighting device of the type shown in FIG. 3 offers the advantage that the light guide 12 can be easily installed in the support rail 13 with the correct orientation of the guide being ensured by the presence of the protuberances 11. FIG. 4, for example, shows such a lighting device 19 installed below the window in the door 20 of a car to illuminate the interior of the car and also to indicate to the occupants the location of items such as the door handle and window controls.

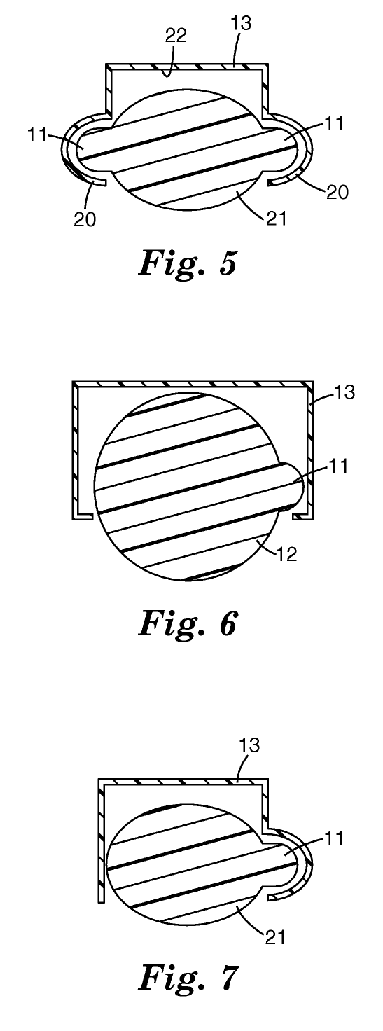

The light guide of FIG. 2 can be modified further by changing the cross-section of the basic form of the light guide to which the protuberances 11 are added. For example, the protuberances 11 could be added to a light guide having an elliptical or a rectangular cross-section, instead of a circular cross-section as shown in FIG. 2. The lighting device of FIG. 3 can also be modified by changing the shape of the support rail 13 in which the light guide 12 is located. One alternative shape for the support rail 13, which provides specific locating portions 20 for the protuberances 11, is illustrated in FIG. 5 (the light guide 21, in this case, being shown as having an elliptical cross-section): it will be understood that, due to the existence of the locating portions 20 in the support rail 13, it is not necessary for the back face 22 of the support rail to contact the light guide 21 in order to restrict the movement of the latter within the rail. As a further alternative, the light guides 12, 21 of FIGS. 3 and 5 can be formed with only one protuberance 11, with corresponding modifications being made to the shape of the support rail 13 as shown in FIGS. 6 and 7.

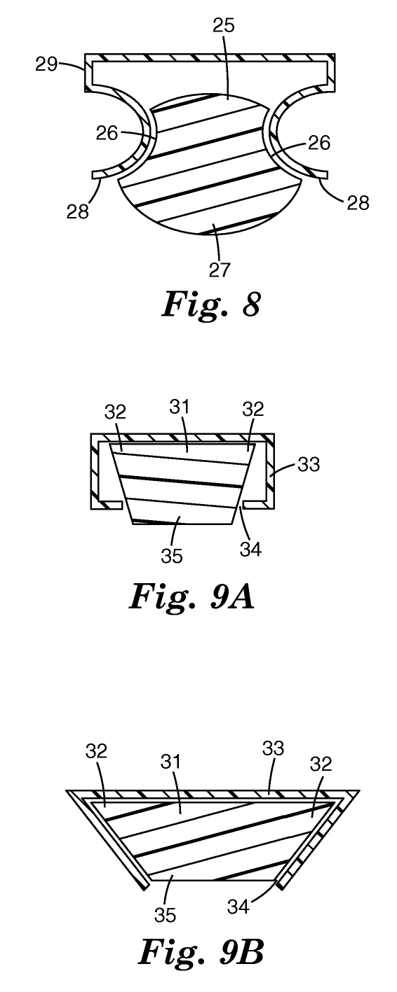

FIG. 8 illustrates an alternative form of lighting device in accordance with the invention, in which the location features on the light guide 25 take the form of cut-out areas 26 rather than protuberances. In this case, the light guide 25 in which the cut-out areas 26 are formed has a circular cross-section but it could, for example, have an elliptical or rectangular cross-section instead. FIG. 8 shows two cut-out areas 26 on opposite sides of the light guide 25, co-operating with correspondingly-shaped portions 28 in the support 29 which, as in FIGS. 3 and 5 to 7, has the form of an elongate hollow rail with an opening in one side through which the light-emitting region 27 the light guide 25 projects. Alternatively, only one cut-out area 26 could be provided, with only one correspondingly-shaped portion 28 being provided in the support rail 29. As explained above with reference to FIG. 2, through a suitable choice of the shape and location of the cut-out areas 26, these location features can be incorporated in a light guide without substantial disruption of the light output of the latter through its light-emitting region.

It will be apparent that the cut-out areas 26 of FIG. 8, like the protuberances 11 of FIGS. 3 and 5 to 7, facilitate the installation of the light guide in its associated support 29 and also ensure that the light guide, once installed, is securely retained in the correct orientation.

FIG. 9A illustrates a lighting device in accordance with the invention, in which the light guide 31 has a rectangular cross-section and is provided with location features 32 in the form of triangular additions to its cross-section at the corners of the latter within the support 33. The support 33 is again in the form of an elongate hollow rail of rectangular cross-section with an opening 34 in one side through which the light-emitting region 35 of the light guide 31 projects. The location features 32 ensure that the light guide 31 is held in the support rail 33 by contact between the light guide and the back face of the support rail, and by the engagement between the sides of the opening 34 and the sides of the light guide. Depending on the exact shape of the light guide 31 and the flexibility of the support rail 33, it may be possible to push the light guide into the support rail 33 through the opening 34: alternatively, the light guide can be slid into the support rail from one end.

FIG. 9B illustrates a modification of the lighting device shown in FIG. 9A, in which the support rail 33 has a cross-section similar to that of the light guide 31, again ensuring that the light guide is held securely within the support rail but, in this case, with the light-emitting region 35 positioned in the opening 34.

In both FIG. 9A and FIG. 9B, the location features 32 can be incorporated in a light guide 31 without substantial disruption of the light output of the guide through the light-emitting region 35.

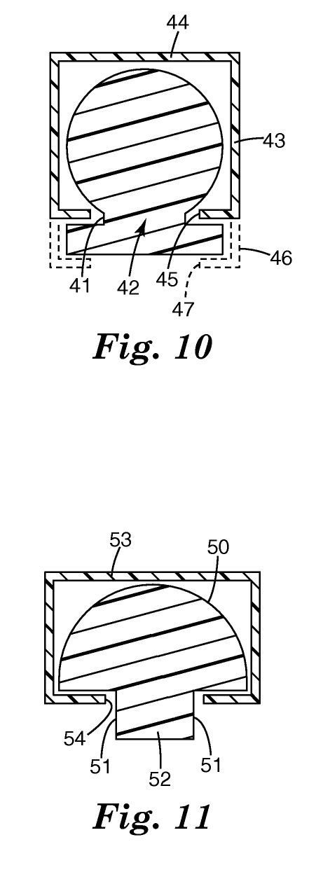

FIG. 10 illustrates another lighting device in accordance with the invention, in which a location feature is provided in the light-emitting region of the light guide. The location feature 40 has, in cross-section, the general form of an inverted “T” with a shortened leg 41 extending from the light-emitting region 42 of the light guide 43. The light guide 43 is shown as having a circular cross-section but it could, for example, have an elliptical or rectangular cross-section instead. Generally, whatever the cross-section of the light guide 43, the dimensions of the leg 41 of the location feature 40 are selected to ensure that the light output of the light guide is transmitted through the location feature substantially unaltered. The support 44 of the light guide 43 again has the form of an elongate hollow rail of rectangular cross-section but, in this case, the leg 41 of the location feature 40 is located in the opening 45 provided in one side of the support rail 44 with the remainder of the location feature located on the outside of the support rail to hold the light guide 43 in position. To form a lighting device of this type, the light guide 42 could be pushed into the support rail 44 through the front opening 45 or, if necessary, slid into the support rail from one end of the latter.

The dotted lines 46 in FIG. 10 illustrate a modification of the support rail 44, in which the support rail is extended around the remainder of the location feature 40 so that the latter is completely enclosed except for an opening 47 through which light emitted through the region 42 of the light guide 43 can pass.

FIG. 11 illustrates a further lighting device in accordance with the invention, in which the location features comprise cut-out areas in the light guide. In this case, the light guide 50 has a circular cross-section and the cut-out areas 51 are located one on either side of the light-emitting region 52 of the guide. The extreme surface of the light-emitting region 52 may be flattened, as shown, so that the light-emitting region has a rectangular cross-section or the residual rounded shape from the original circular cross-section of the light guide may be retained. The light guide support 53 again has the form of an elongate hollow rail with an opening 54 in one side through which, in this case, the light-emitting region 52 of the light guide projects with the remainder of the light guide 50 being located within, and retained by, the rail. The cut-out areas 51 should be such that, although the light guide is securely located within the support rail 53, the light-emitting region 52 of the light guide 50 is substantially retained so that the light output through this region is substantially unaltered. As with the lighting device of FIG. 10, the light guide 50 could be pushed into the support rail 53 through the opening 54 or, if necessary, slid into the support rail from one end of the latter.

It will be appreciated that, although the light guide 50 of FIG. 11 has a circular cross-section, a similar lighting device could be formed from a light guide with an elliptical or a rectangular cross-section.

In any of the above-described lighting devices in accordance with the invention, it is not essential for the location features 11, 26, 32, 40, 51 on the light guide to extend continuously along the length of the guide. The location features could, instead, just be provided at intervals along the length of the light guide. Likewise, it is also not essential for the light guide support 13, 29, 33, 44, 53 to have the form of a continuous rail, extending along the complete length of the light guide. The support could, instead, take the form of clips provided along the length of the light guide. In the case in which both the location features and the support do not extend along the complete length of the light guide, they would have to be positioned so that they are capable of engaging with each other. Typically, although not essentially, the light guide support will be required to have minimal effect on the light-emitting region of the light guide and, consequently, on the light output through the latter.

What is claimed is:

1. A lighting device comprising a side-light light guide located in a support, the light guide having, along at least part of its length, at least one location feature formed thereon/therein, the location feature(s) being engaged by the support to retain the light guide therein.

2. A lighting device as claimed in claim 1, in which the light guide has a light-emitting region and the engagement of the support with the location feature(s) also serves to retain the light guide in a predetermined orientation in the support.

3. A lighting device as claimed in claim 1 or claim 2, in which the said at least one location feature extends along the length of the light guide.

4. A lighting device as claimed in any one of the preceding claims, in which the said at least one location feature comprises a protuberance on the light guide.

5. A lighting device as claimed in claim 4, in which the protuberance is formed from the same material as the light guide.

6. A lighting device as claimed in claim 5, in which the light guide is a moulded article and the protuberance is integrally-moulded therewith.

7. A lighting device as claimed in any one of claims 1 to 3, in which the said at least one location feature comprises a cut-out area in the light guide.

8. A lighting device as claimed in any one of the preceding claims, in which the cross-section of the light guide, excluding the location feature(s), is circular, elliptical or rectangular in shape.

9. A lighting device as claimed in any one of the preceding claims, comprising light-extraction elements arranged to direct light out of the light guide through a light-emitting region extending lengthwise of the guide.

10. A lighting device as claimed in claim 9, in which the light-extraction elements are formed in the periphery of the light guide on one side of thereof, and the light-emitting region is on the other side of the guide.

11. A lighting device as claimed in claim 10, in which the said at least one location feature is positioned on the periphery of the light guide between the light-extraction elements and the light-emitting region of the guide.

12. A lighting device as claimed in claim 11, in which the light guide is provided with two location features in opposed positions on the periphery of the guide between the light-extraction elements and the light-emitting region of the guide.

13. A lighting device as claimed in claim 10, in which the said at least one location feature is positioned on the periphery of the light guide in the light-emitting region thereof.

14. A lighting device as claimed in any one of claims 9 to 13, in which the light-extraction elements comprise optically-smooth reflecting surfaces.

15. A lighting device as claimed in any one of the preceding claims, in which the light guide is formed from a flexible material.

16. A lighting device as claimed in any one of the preceding claims, in which the light output of the light guide is substantially unaffected by the presence of the support.

17. A lighting device as claimed in any one of the preceding claims, in which the support extends along the length of the light guide.

18. A lighting device as claimed in any one of the preceding claims, in which the support is formed with an opening for the passage of light emitted by the light guide.

19. A lighting device as claimed in claim 18 when appended to claim 17, in which the opening extends along the length of the light guide.

20. A lighting device as claimed in claim 18 or claim 19, in which the light guide can be pushed into the support through the said opening.

21. A lighting device as claimed in any one of the preceding claims, including at least one light source positioned to inject light into the light guide at one end thereof.

22. A side-light light guide having a light-emitting region and, along at least part of its length, at least one location feature by which the guide can be retained in a predetermined orientation in a support, the location feature(s) being so formed and positioned on/in the guide that the light output of the guide through the light-emitting region is substantially unaffected thereby.

23. A light guide as claimed in claim 22, in which the said at least one location feature extends along the length of the guide.

24. A light guide as claimed in claim 22 or claim 23, in which the said at least one location feature comprises a protuberance on the guide.

25. A light guide as claimed in claim 24, in which the protuberance is formed from the same material as the guide.

26. A light guide as claimed in claim 25, in which the guide is a moulded article and the protuberance is integrally-moulded therewith.

27. A light guide as claimed in claim 22 or claim 23, in which the said at least one location feature comprises a cut-out area in the guide.

28. A light guide as claimed in any one of claims 22 to 27, in which the cross-section of the guide, excluding the location feature(s), is circular, elliptical or rectangular in shape.

29. A light guide as claimed in any one of claims 22 to 28, comprising light-extraction elements arranged to direct light out of the guide through a light-emitting region extending lengthwise of the guide.

30. A light guide as claimed in claim 29, in which the light-extraction elements are formed in the periphery of the guide on one side of thereof, and the light-emitting region is on the other side of the guide.

31. A light guide as claimed in claim 30, in which the said at least one location feature is positioned on the periphery of the guide between the light-extraction elements and the light-emitting region of the guide.

32. A light guide as claimed in claim 31, in which the guide is provided with two location features in opposed positions on the periphery of the guide between the light-extraction elements and the light-emitting region of the guide.

33. A light guide as claimed in claim 30, in which the said at least one location feature is positioned on the periphery of the guide in the light-emitting region thereof.

34. A light guide as claimed in any one of claims 29 to 33, in which the light-extraction elements comprise optically-smooth reflecting surfaces.

35. A light guide as claimed in any one of claims 22 to 34, which is formed from a flexible material.

36. A lighting device comprising a light guide as claimed in any one of claims 22 to 35 located in a support, in which the support engages the location feature(s) of the light guide to retain the guide therein in a predetermined orientation.

37. A lighting device as claimed in claim 36, in which the light output of the light guide is substantially unaffected by the presence of the support.

38. A lighting device as claimed in claim 36 or claim 37, in which the support extends along the length of the light guide.

39. A lighting device as claimed in any one of claims 36 to 38, in which the support is formed with an opening for the passage of light emitted by the light guide.

40. A lighting device as claimed in claim 39 when appended to claim 38, in which the opening extends along the length of the light guide.

41. A lighting device as claimed in claim 39 or claim 40, in which the light guide can be pushed into the support through the said opening.

42. A lighting device as claimed in any one of claims 36 to 41, including at least one light source positioned to inject light into the guide at one end thereof.
